(19) United States
(12) Patent Application Publication
(10) Pub. No.: US 2012/0240141 A1
(43) Pub. Date: Sep. 20, 2012

(54) METHODS AND SYSTEMS FOR CONSUMING MEDIA CONTENT AMONG A GROUP OF AT LEAST TWO ENTITIES

(75) Inventors: Wong Hoo Sim, Singapore (SG); Willie Png, Singapore (SG)

(73) Assignee: CREATIVE TECHNOLOGY LTD, Singapore (SG)

(21) Appl. No.: 13/513,386

(22) PCT Filed: Nov. 29, 2010
(86) PCT No.: PCT/SG10/00446

§ 371 Date: Jun. 1, 2012

(30) Foreign Application Priority Data
Dec. 1, 2009 (SG) 200907971-6

(51) Int. Cl. H04N 21/258

(52) U.S. Cl. 725/12

(57) ABSTRACT

There are provided methods and systems for consuming media content among a group of at least two entities. The at least two entities may include a host entity. It is advantageous that the host entity is able to determine the at least one reaction of each of the entities other than the host entity in real-time during consumption of the media content. It is preferable that the host entity is able to ascertain a spontaneous perception of the media content by each of the entities other than the host entity by determining the at least one reaction of each of the entities other than the host entity.

### FIELD OF INVENTION

This invention relates to consumption of media content among a group of at least two entities, the consumption of the media content being enabled by a method and system.

### BACKGROUND

It is a typical process for people to enter into discussions by relating to their individual experiences and by sharing their individual opinions. This process is instrumental in both determining common ground amongst groups of people and forging bonds between one another. One of the most common topics during the aforementioned discussions typically centre around entertainment subject matter, such as, for example, movies, television programmes, music, books, and so forth.

Some people take the opportunity to enter into the discussions for bonding purposes immediately after consuming the entertainment subject matter. The discussions may be done either on a face-to-face basis or via a communications/data network. However, it should be noted that the discussions are typically carried out after consuming the entertainment subject matter and not during the consumption of the entertainment subject matter as carrying out the discussions while consuming the entertainment subject matter may be distracting to all who are consuming the entertainment subject matter. While there may be an increasing number of people who either blog or tweet about their thoughts during consumption of the entertainment subject matter, it is evident that their thoughts are available only after they have composed their thoughts and lacks a certain degree of spontaneity. Thus, there is currently no available manner which captures the reaction of people consuming the entertainment subject matter on a real-time basis and provides a perspective of a spontaneous reaction of people while consuming the entertainment subject matter.

As such, the present invention aims to address this problem and be able to capture the spontaneous reaction of people while consuming the entertainment subject matter.

### SUMMARY

In a first aspect, there is provided a method for consuming media content among a group of at least two entities. The at least two entities may include a host entity. The method includes the host entity providing the media content for consumption by the at least two entities, the host entity being located at a host location; entities other than the host entity from the at least two entities receiving the media content at various locations other than the host location through internet-enabled devices of each entity other than the host entity; and the entities other than the host entity providing the host entity with at least one reaction during consumption of the media content, the at least one reaction being selected from a group comprising: facial expression, body movements, and vocal expression as real-time video images of the entities other than the host entity are transmitted to the host entity. It is advantageous that the host entity is able to determine the at least one reaction of each of the entities other than the host entity in real-time during consumption of the media content. It is preferable that the host entity is able to ascertain a spontaneous perception of the media content by each of the entities other than the host entity by determining the at least one reaction of each of the entities other than the host entity.

The media content may be selected from, for example, video content, audio content, textual content and the like. The media content may be stored locally at both the host location and a location of each entity.

The method may further include the host entity inviting the entities other than the host entity to a virtual platform for consuming the media content. The virtual platform may be available only to the entities other than the host entity who have been provided with access rights to the virtual platform.

There is also provided a second method for consuming media content among a group of at least two entities, the at least two entities including a host entity. The method includes the host entity providing the media content for consumption by the at least two entities, the host entity being located at a host location; entities other than the host entity from the at least two entities receiving the media content at various locations other than the host location through internet-enabled devices of each entity other than the host entity; and the entities other than the host entity receiving at least one reaction from the host entity during consumption of the media content, the at least one reaction being selected from a group comprising: facial expression, body movements, and vocal expression as real-time video images of the host entity are transmitted to the entities other than the host entity.

It is advantageous that the entities other than the host entity are able to determine the at least one reaction of the host entity in real-time during consumption of the media content. Preferably, each of the entities other than the host entity is able to ascertain a spontaneous perception of the media content by the host entity by determining the at least one reaction of the host entity. Preferably, the media content is selected from, for example, video content, audio content, textual content and the like. The media content may be stored locally at both the host location and a location of each entity.

The second method may also further include the host entity inviting the entities other than the host entity to a virtual platform for consuming the media content, whereby the virtual platform is available only to the entities other than the host entity who have been provided with access rights to the virtual platform.

There is also provided a system for consuming media content among a group of at least two entities, the at least two entities including a host entity. The system includes a host apparatus at a location of the host entity, the host apparatus being for viewing of the media content from a media content depository, for viewing of real-time video images of the entities other than the host entity, and for capturing real-time video images of the host entity; and at least one secondary apparatus at a location of each of the entities other than the host entity, the secondary apparatus being for viewing of the media content, for viewing of real-time video images of the host entity, and for capturing real-time video images of the entities other than the host entity. Preferably, the host entity is able to determine the at least one reaction of each of the entities other than the host entity in real-time during consumption of the media content when reviewing the real-time video images of the entities other than the host entity, the at least one reaction being selected from a group comprising: facial expression, body movements, and vocal expression. Advantageously, the host entity is able to ascertain a spontaneous perception of the media content by each of the entities other than the host entity by determining the at least one reaction of each of the entities other than the host entity.

Preferably, the media content is selected from, for example, video content, audio content, textual content and the like. The media content depository may be incorporated within the host apparatus. Content from the media content depository may be able to be incorporated in an electronic book created by the host entity to bolster textual content in the electronic book.

In the system, the at least one secondary apparatus may receive an invitation transmitted from the host apparatus via a virtual platform to access the virtual platform for consuming the media content. The virtual platform may be available only to the at least one secondary apparatus that have been provided with access rights to the virtual platform.

In the system, each of the host apparatus and the at least one secondary apparatus may include a display module for showing the media content and the real-time video images; an image and audio capturing module for capturing real-time video images; and a communications module for enabling communications between either the host apparatus or the at least on secondary apparatus and a virtual platform for consuming the media content.

There is also provided a second system for consuming media content among a group of at least two entities, the at least two entities including a host entity. The system includes a host apparatus at a location of the host entity, the host apparatus being for viewing of the media content from a media content depository, for viewing of real-time video images of the entities other than the host entity, and for capturing real-time video images of the host entity; and at least one secondary apparatus at a location of each of the entities other than the host entity, the at least one secondary apparatus being for viewing of the media content, for viewing of real-time video images of the host entity, and for capturing real-time video images of the entities other than the host entity. Each of the entities other than the host entity may be able to determine the at least one reaction of the host entity in real-time during consumption of the media content when reviewing the real-time video images of the host entity, the at least one reaction being selected from a group comprising: facial expression, body movements, and vocal expression. Advantageously, each of the entities other than the host entity is able to ascertain a spontaneous perception of the media content by the host entity by determining the at least one reaction of the host entity.

The media content may be selected from for example, video content, audio content, textual content and the like. The media content depository may be incorporated within the host apparatus. Content from the media content depository may be able to be incorporated in an electronic book created by the host entity to bolster textual content in the electronic book.

The at least one secondary apparatus may receive an invitation transmitted from the host apparatus via a virtual platform to access the virtual platform for consuming the media content, with the virtual platform being made available only to the at least one secondary apparatus that have been provided with access rights to the virtual platform.

Each of the host apparatus and the at least one secondary apparatus may include: a display module for showing the media content and the real-time video images; an image and audio capturing module for capturing real-time video images; and a communications module for enabling communications between either the host apparatus or the at least one secondary apparatus and a virtual platform for consuming the media content.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a process flow of a first embodiment of a method of the present invention.

FIG. 2 shows a process flow of a second embodiment of the method of the present invention.

FIG. 3 shows a schematic view of a system of the present invention.

FIG. 4 shows a non-limiting representation of a graphical user interface of a virtual platform of the present invention.

### DESCRIPTION OF PREFERRED EMBODIMENTS

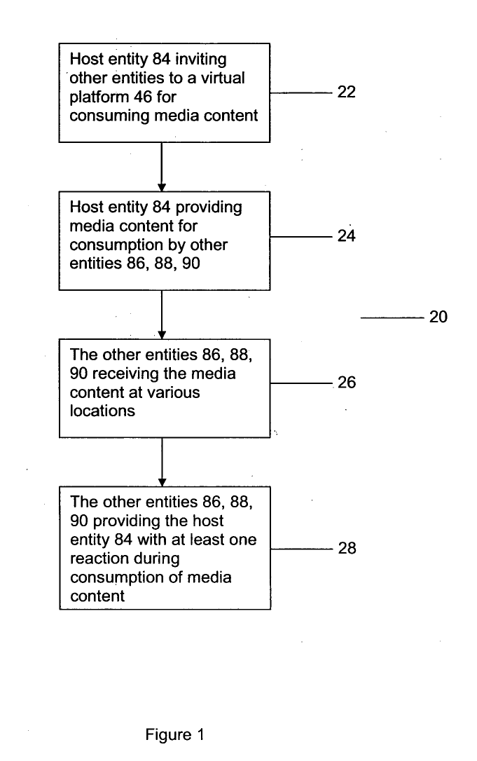

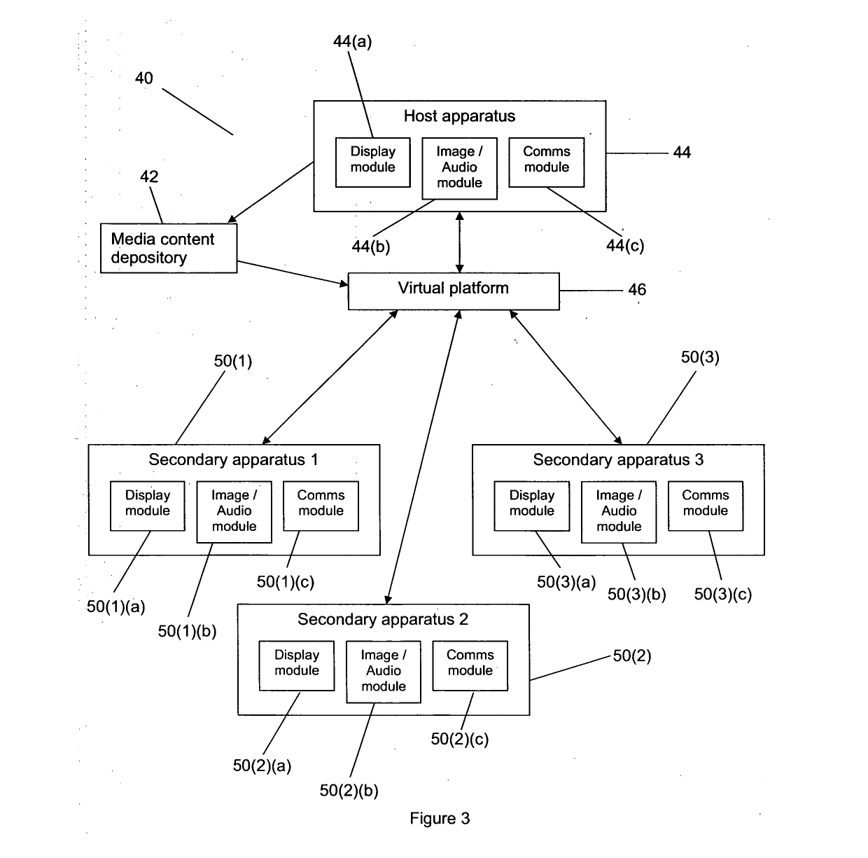

Referring to FIG. 1, there is provided a first embodiment of a method 20 for consuming media content among a group of at least two entities. Reference is also made to FIG. 3 for a schematic view of a system of the present invention. The at least two entities may include a host entity. The host entity may be a person who initiates an event for consuming the media content. Other entities in the grouping of the at least two entities may be associated with the host entity through some relationship or other. The other entities should be known to the host entity as the other entities are involved with the event for consuming media content through the host entity. The media content may be selected from, for example, video content, audio content, textual content and so forth. The textual content may be in a form of an electronic book.

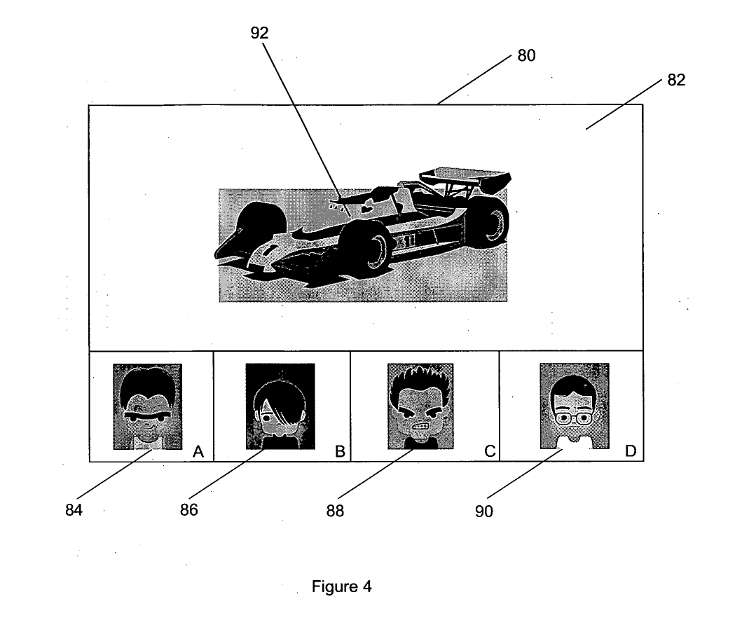

The method 20 includes the host entity inviting the entities other than the host entity to a virtual platform for consuming the media content (22). The virtual platform 46 may be a URL with access controls in place. The virtual platform 46 may be available only to the entities other than the host entity who have been provided with access rights to the virtual platform 46. The virtual platform 46 may be presented in a non-limiting graphical user interface 80 form as shown in FIG. 4, where a main portion 82 displays media content 92, and video feeds of all entities 86, 88, 90 inclusive of the host entity 84 is also displayed on the graphical user interface 80. In this instance, the media content 92 is a video showing a racing car. The video images (video feeds) of all entities 84, 86, 88, 90 should at least show the faces of each of the entities 84, 86, 88, 90. The importance of showing at least the faces of each of the entities 84, 86, 88, 90 will be apparent from the description which will be provided in the subsequent sections.

The host entity 84 may provide the media content for consumption by the at least two entities at the virtual platform 46 (24), with the host entity 84 being located at a host location. Entities 86, 88, 90 other than the host entity 84 from the at least two entities may receive the media content at various locations other than the host location when each of the entities accesses the virtual platform 46 (26) from their respective internet-enabled devices. It should be appreciated that the internet-enabled devices may be either portable or non-portable. The media content may be stored locally at both the host location and a location of each entity.

When the host entity 84 accesses the virtual platform 46, it should be noted that the entities 86, 88, 90 other than the host entity 84 may provide the host entity 84 with at least one reaction during consumption of the media content, the at least one reaction (28) being, for example, facial expression, body movements, vocal expression and so forth as real-time video images of the entities 86, 88, 90 other than the host entity 84 are transmitted to the host entity 84. The importance of showing at least the faces of each of the entities 84, 86, 88, 90 may aid in determining the facial expression and vocal expression of the entities 86, 88, 90 other than the host entity 84. Consequently, the host entity 84 is able to determine the at least one reaction of each of the entities 86, 88, 90 other than the host entity 84 in real-time during consumption of the media content 92. When the host entity 84 is able to determine the at least one reaction of each of the entities 86, 88, 90, the host entity 84 is able to ascertain a spontaneous perception (whether positive or negative) of the media content 92 by each of the entities 86, 88, 90 other than the host entity 84.

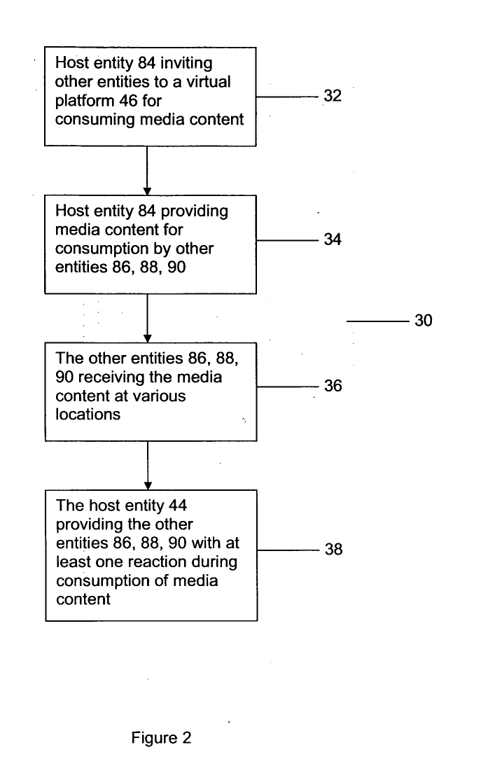

Referring to FIG. 2, there is provided a second embodiment of a method 40 for consuming media content among a group of at least two entities. The at least two entities include a host entity. The host entity may be a person who initiates an event for consuming the media content. Other entities in the grouping of the at least two entities may be associated with the host entity through some relationship or other. The other entities should be known to the host entity as the other entities are involved with the event for consuming media content through the host entity. The media content may be selected from, for example, video content, audio content, textual content and so forth. The textual content may be in a form of an electronic book.

The method 30 includes the host entity inviting the entities other than the host entity to a virtual platform 46 for consuming the media content (32). The virtual platform 46 may be a URL with access controls in place. The virtual platform 46 may be available only to the entities other than the host entity who have been provided with access rights to the virtual platform 46. The graphical user interface 80 of the virtual platform 46 may be presented in a non-limiting form as shown in FIG. 4, where a main portion 82 displays media content 92, and video feeds of all entities 86, 88, 90 inclusive of the host entity 84 is also displayed on the graphical user interface 80. In this instance, the media content 92 is a video showing a racing car. The video images (video feeds) of all entities 84, 86, 88, 90 should at least show the faces of each of the entities 84, 86, 88, 90. The importance of showing at least the faces of each of the entities 84, 86, 88, 90 will be apparent from the description which will be provided in the subsequent sections.

The host entity 84 providing the media content for consumption by the at least two entities at the virtual platform 46 (34), with the host entity 84 being located at a host location. Entities 86, 88, 90 other than the host entity 84 from the at least two entities may receive the media content at various locations other than the host location when each of the entities accesses the virtual platform 46 (36) from their respective internet-enabled devices. It should be appreciated that the internet-enabled devices may be either portable or non-portable. The media content may be stored locally at both the host location and a location of each entity.

When the entities 86, 88, 90 other than the host entity 84 accesses the virtual platform 46, it should be noted each of the entities 86, 88, 90 may receiving at least one reaction from the host entity 84 during consumption of the media content, the at least one reaction (38) such as, for example, facial expression, body movements, vocal expression and so forth as real-time video images of the host entity 84 are transmitted to the entities 86, 88, 90. The importance of showing at least the faces of the host entity 84 may aid in determining the facial expression and vocal expression of the host entity 84. Consequently, each of the entities 86, 88, 90 is able to determine the at least one reaction of the host entity 84 in real-time during consumption of the media content 92. When each of the entities 86, 88, 90 is able to determine the at least one reaction of the host entity 84, each of the entities 86, 88, 90 is able to ascertain a spontaneous perception (whether positive or negative) of the media content 92 by the host entity 84.

Referring to FIG. 3, there is provided a system 40 for consuming media content among a group of at least two entities. The at least two entities may include a host entity 84. The host entity 84 may be a person who initiates an event for consuming the media content. Other entities in the grouping of the at least two entities may be associated with the host entity 84 through some relationship or other. The other entities should be known to the host entity 84 as the other entities are involved with the event for consuming media content through the host entity 84. In the system 40, the host entity 84 may be represented by a host apparatus 44 used in the system 40. The host apparatus 44 may be internet-enabled. The host apparatus 44 may be either portable or non-portable. Similarly, each of the entities other than the host entity 84 may be represented by at a secondary apparatus 50. The secondary apparatus 50 may be internet-enabled. The secondary apparatus 50 may be either portable or non-portable. It should be appreciated that the host apparatus 44 and the at least one secondary apparatus 50 may be identical devices. The media content may be selected from, for example, video content, audio content, textual content and so forth. The textual content may be in a form of an electronic book.

The system 40 includes the host apparatus 44 at a location of the host entity, with the host apparatus 44 being for viewing of the media content drawn from a media content depository 42. The media content depository 42 may be administered by at least one provider of media content and may be accessible via a data network (for example, the Internet). The media content depository 42 may also be incorporated within the host apparatus 44. Content from the media content depository 42 may be incorporated in an electronic book created by the host entity 84 to bolster the textual content in the electronic book.

The host apparatus 44 may also be for viewing of real-time video images of the entities other than the host entity 84, and for capturing real-time video images of the host entity 84. The host apparatus 44 may include a display module 44(a) for showing the media content and the real-time video images, an image and audio capturing module 44(b) for capturing real-time video images; and a communications module 44(c) for enabling communications between the host apparatus 44 and a virtual platform 46 for consuming the media content.

There is also at least one secondary apparatus 50 at a location of each of the entities other than the host entity 84. Each of the at least one secondary apparatus 50 may be for viewing of the media content, for viewing of real-time video images of the host entity 84, and for capturing real-time video images of the entities other than the host entity 84. It should be noted that the electronic book created by the host entity 84 bolstered with content from the media content depository 42 may not be consumed by each of the other entities in a manner intended by the host entity 84 if the at least one secondary apparatus 50 does not include the media content depository 42. This is because the content from the media content depository 42 may not be accessible by the entity at the at least one secondary apparatus 50 due to either bandwidth or legal issues.

The at least one secondary apparatus 50 may include a display module 50(a) for showing the media content and the real-time video images, an image and audio capturing module 50(b) for capturing real-time video images; and a communications module 50(c) for enabling communications between the at least one secondary apparatus 50 and the virtual platform 46 for consuming the media content. Each of the at least one secondary apparatus 50 may receive an invitation transmitted from the host apparatus 44 to access the virtual platform 46 for consuming the media content. The invitation may be sent by the host apparatus 44 via the virtual platform 46. Access to the virtual platform 46 may be available only to the at least one secondary apparatus 50 that have been provided with access rights to the virtual platform 46. A non-limiting representation of the graphical user interface 80 of the virtual platform 46 is provided in FIG. 4 as per the description in the earlier section.

In the system 40, the host entity 84 (through the host apparatus 44) may be able to determine the at least one reaction of each of the entities other than the host entity 84 in real-time during consumption of the media content when reviewing the real-time video images of the entities other than the host entity 84 on the host apparatus 44. The at least one reaction may include, for example, facial expression, body movements, vocal expression and so forth. When the host entity 84 is able to determine the at least one reaction of each of the entities other than the host entity 84, the host entity 84 is consequently able to ascertain a spontaneous perception (whether positive or negative) of the media content by each of the entities other than the host entity 84.

Similarly, each of the entities other than the host entity 84 is also able to determine the at least one reaction of the host entity 84 in real-time during consumption of the media content when reviewing the real-time video images of the host entity 84 on their respective secondary apparatus 50. The at least one reaction may include, for example, facial expression, body movements, vocal expression and so forth. When each of the entities other than the host entity 84 is also able to determine the at least one reaction of the host entity 84, the host entity 84 is consequently able to ascertain a spontaneous perception (whether positive or negative) of the media content by each of the entities other than the host entity 84.

Whilst there has been described in the foregoing description preferred embodiments of the present invention, it will be understood by those skilled in the technology concerned that many variations or modifications in details of design or construction may be made without departing from the present invention.

1. A method for consuming media content among a group of at least two entities, the at least two entities including a host entity, the method including: the host entity providing the media content for consumption by the at least two entities, the host entity being located at a host location;
entities other than the host entity from the at least two entities receiving the media content at various locations other than the host location through internet-enabled devices of each entity other than the host entity; and
the entities other than the host entity providing the host entity with at least one reaction during consumption of the media content, the at least one reaction being selected from a group consisting of: facial expression, body movements, and vocal expression as real-time video images of the entities other than the host entity are transmitted to the host entity;
wherein the host entity is able to determine the at least one reaction of each of the entities other than the host entity in real-time during consumption of the media content.

2. (canceled)

3. The method of claim 1, further including the host entity inviting the entities other than the host entity to a virtual platform for consuming the media content.

4. The method of claim 3, wherein the virtual platform is available only to the entities other than the host entity who have been provided with access rights to the virtual platform.

5. The method of claim 1, wherein the host entity is able to ascertain a spontaneous perception of the media content by each of the entities other than the host entity by determining the at least one reaction of each of the entities other than the host entity.

6. The method of claim 1, wherein the media content is stored locally at both the host location and a location of each entity.

7. A method for consuming media content among a group of at least two entities, the at least two entities including a host entity, the method including: the host entity providing the media content for consumption by the at least two entities, the host entity being located at a host location;
entities other than the host entity from the at least two entities receiving the media content at various locations other than the host location through internet-enabled devices of each entity other than the host entity; and
the entities other than the host entity receiving at least one reaction from the host entity during consumption of the media content, the at least one reaction being selected from a group consisting of: facial expression, body movements, and vocal expression as real-time video images of the host entity are transmitted to the entities other than the host entity;
wherein the entities other than the host entity are able to determine the at least one reaction of the host entity in real-time during consumption of the media content.

8. (canceled)

9. The method of claim 7, further including the host entity inviting the entities other than the host entity to a virtual platform for consuming the media content.

10. The method of claim 9, wherein the virtual platform is available only to the entities other than the host entity who have been provided with access rights to the virtual platform.

11. The method of claim 7, wherein each of the entities other than the host entity is able to ascertain a spontaneous perception of the media content by the host entity by determining the at least one reaction of the host entity.

12. The method of claim 7, wherein the media content is stored locally at both the host location and a location of each entity.

13. A system for consuming media content among a group of at least two entities, the at least two entities including a host entity, the system including: a host apparatus at a location of the host entity, the host apparatus being for viewing of the media content from a media content depository, for viewing of real-time video images of the entities other than the host entity, and for capturing real-time video images of the host entity; and
at least one secondary apparatus at a location of each of the entities other than the host entity, the secondary apparatus being for viewing of the media content, for viewing of real-time video images of the host entity, and for capturing real-time video images of the entities other than the host entity,
wherein the host entity is able to determine the at least one reaction of each of the entities other than the host entity in real-time during consumption of the media content when reviewing the real-time video images of the entities other than the host entity, the at least one reaction being selected from a group consisting of: facial expression, body movements, and vocal expression.

14. (canceled)

15. The system of claim 13, wherein the at least one secondary apparatus receives an invitation transmitted from the host apparatus via a virtual platform to access the virtual platform for consuming the media content, wherein the virtual platform is available only to the at least one secondary apparatus that have been provided with access rights to the virtual platform.

16. (canceled)

17. (canceled)

18. The system of claim 13, wherein each of the host apparatus and the at least one secondary apparatus includes:
a display module for showing the media content and the real-time video images;
an image and audio capturing module for capturing real-time video images; and
a communications module for enabling communications between either the host apparatus or the at least on secondary apparatus and a virtual platform for consuming the media content.

19. The system of claim 13, wherein the media content depository is incorporated within the host apparatus.

20. The system of claim 13, wherein content from the media content depository is able to be incorporated in an electronic book created by the host entity to bolster textual content in the electronic book.

21. A system for consuming media content among a group of at least two entities, the at least two entities including a host entity, the system including: a host apparatus at a location of the host entity, the host apparatus being for viewing of the media content from a media content depository, for viewing of real-time video images of the entities other than the host entity, and for capturing real-time video images of the host entity; and
at least one secondary apparatus at a location of each of the entities other than the host entity, the at least one secondary apparatus being for viewing of the media content, for viewing of real-time video images of the host entity, and for capturing real-time video images of the entities other than the host entity,
wherein each of the entities other than the host entity is able to determine the at least one reaction of the host entity in real-time during consumption of the media content when reviewing the real-time video images of the host entity, the at least one reaction being selected from a group consisting of: facial expression, body movements, and vocal expression.

22. (canceled)

23. The system of claim 21, wherein the at least one secondary apparatus receives an invitation transmitted from the host apparatus via a virtual platform to access the virtual platform for consuming the media content, wherein the virtual platform is available only to the at least one secondary apparatus that have been provided with access rights to the virtual platform.

24. (canceled)

25. (canceled)

26. The system of claim 21, wherein each of the host apparatus and the at least one secondary apparatus includes:
a display module for showing the media content and the real-time video images;
an image and audio capturing module for capturing real-time video images; and
a communications module for enabling communications between either the host apparatus or the at least one secondary apparatus and a virtual platform for consuming the media content.

27. The system of claim 21, wherein the media content depository is incorporated within the host apparatus.

28. The system of claim 21, wherein content from the media content depository is able to be incorporated in an electronic book created by the host entity to bolster textual content in the electronic book.
